(19) United States
(12) Patent Application Publication
(10) Pub. No.: US 2026/0059080 A1
(43) Pub. Date: Feb. 26, 2026

(54) PROJECTOR APPARATUS

(71) Applicant: BENQ CORPORATION, Taipei City (TW)

(72) Inventor: Chih-Pen Huang, New Taipei City (TW)

(21) Appl. No.: 19/069,246

(22) Filed: Mar. 4, 2025

(30) Foreign Application Priority Data
Aug. 22, 2024 (TW) 113131538

(51) Int. Cl. H04N 9/31; G06T 7/73

(52) U.S. Cl. CPC H04N 9/3185; G06T 7/73

(57) ABSTRACT

A projector apparatus of automatically calibrating position of an image detection module includes a projection lens, the image detection module, a drive module and an operation processor. The projection lens is used to project a feature pattern. The image detection module is disposed adjacent to the projection lens and used to acquire a detection image containing the feature pattern. The drive module is electrically connected to the image detection module. The operation processor is electrically connected to the projection lens, the image detection module and the drive module, and used to compare the detection image with a preset condition and then decide whether to adjust a detection angle of the image detection module via the drive module in accordance with a comparison result.

### BACKGROUND OF THE INVENTION

### 1. Field of the Invention

The present invention relates to a projector apparatus, and more particularly, to a projector apparatus of automatically calibrating position of an image detection module.

### 2. Description of the Prior Art

With the advanced technology, indoor simulated sports gradually become popular; for example, the indoor simulated golf course is more well-known because it requires a much smaller area than the real golf course. The conventional indoor simulated golf course projects the course image onto a projection curtain in front of the user, and analyzes position the golf ball hitting the projection curtain to provide batting information for the user. However, the conventional golf simulation apparatus is disposed on the ceiling, and the specific area on the ground that corresponds to position of the conventional golf simulation apparatus must be restricted to accurately determine the hitting position of the golf ball. In addition, the conventional golf simulation apparatus that is disposed on the ceiling is prone to installation deviation, and needs to be readjusted or reinstalled due to the incorrect installation angle. Therefore, design of a golf simulation device that can automatically correct position of the image detection module is an important issue in the sport equipment industry.

### SUMMARY OF THE INVENTION

The present invention provides a projector apparatus of automatically calibrating position of an image detection module for solving above drawbacks.

According to the claimed invention, a projector apparatus of automatically calibrating position of an image detection module includes a projection lens, the image detection module, a drive module and an operation processor. The projection lens is adapted to project a feature pattern. The image detection module is disposed adjacent to the projection lens and adapted to acquire a detection image containing the feature pattern. The drive module is electrically connected to the image detection module. The operation processor is electrically connected to the projection lens, the image detection module and the drive module, and adapted to compare the detection image with a preset condition and then decide whether to adjust a detection angle of the image detection module by the drive module in accordance with a comparison result.

According to the claimed invention, the projector apparatus further includes an image calibration module electrically connected to the operation processor, and adapted to acquire a calibration image containing the feature pattern. The operation processor utilizes the calibration image to compute a calibration angle of the feature pattern acquired by calibration through keystone correction technology. The image calibration module includes a ToF (Time of Flight) sensor, and the operation processor computes the calibration angle in accordance with a distance detection result of the ToF sensor. The image calibration module includes a structured light sensor, and the operation processor computes the calibration angle in accordance with a stripe deformation result of the structured light sensor.

The projector apparatus of the present invention can utilize the projection lens to project the feature pattern onto the projection area for replacing the conventional correction cardboard. The feature pattern may be distorted or deformed due to an installation angle of the projector apparatus, and the image calibration module can capture the calibration image containing the feature pattern; then, the projector apparatus can compute the calibration angle of the feature pattern converted from the trapezoid form to the rectangle form via the keystone correction technology by several calibration methods, and therefore the projection lens can project the feature pattern without distortion and deformation based on the calibration angle.

After that, the image detection module can capture the detection image that contains the calibrated feature pattern, and analyze the detection image for frame analysis. If the frame analysis is correctly completed, the projector apparatus can utilize the image detection module to focus on the feature pattern projected by the projection lens onto the projection area for acquiring the detection image, and the detection image can be analyzed to acquire the position, the size, the direction, and any related parameters of the effective region inside the projection area for the compensation adjustment and the object tracking operation. If the frame analysis is failed, the detection range of the image detection module may not align with the effective region inside the projection area, and the drive module of the projector apparatus can adaptively adjust the detection angle of the image detection module relative to the projection area in accordance with the calibration angle, and then the image detection module can accurately and effectively capture the detection image containing the calibrated feature pattern.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an appearance diagram of a projector apparatus according to an embodiment of the present invention.

FIG. 2 is a functional block diagram of the projector apparatus according to the embodiment of the present invention.

FIG. 3 is a diagram of a calibration image captured by an image calibration module before image calibration according to the embodiment of the present invention.

FIG. 4 is a diagram of the calibration image captured by the image calibration module after the image calibration according to the embodiment of the present invention.

FIG. 5 is a diagram of a detection image captured by an image detection module before position calibration according to the embodiment of the present invention.

FIG. 6 is a diagram of the detection image captured by the image detection module after the position calibration according to the embodiment of the present invention.

FIG. 7 and FIG. 8 are diagrams of the feature pattern according to other embodiments of the present invention

### DETAILED DESCRIPTION

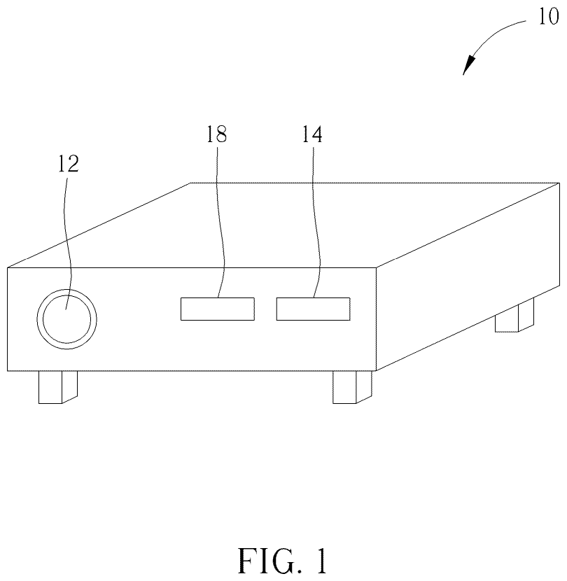

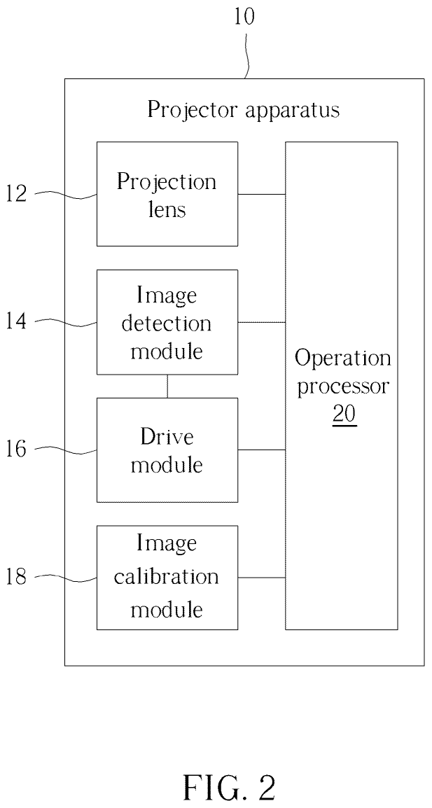

Please refer to FIG. 1 and FIG. 2. FIG. 1 is an appearance diagram of a projector apparatus 10 according to an embodiment of the present invention. FIG. 2 is a functional block diagram of the projector apparatus 10 according to the embodiment of the present invention. The projector apparatus 10 can be applied for a golf simulator apparatus; however, the projector apparatus 10 can be applied to other situations, and other possible embodiment is omitted herein for simplicity. An extra correction cardboard is not required for the projector apparatus 10, and the projector apparatus 10 can automatically calibrate position of the image detection module for providing an accurate calibration result; when the calibration process is completed, the projector apparatus 10 can acquire parameters of the position, a size and a direction of a projection area (such as the projection curtain or the ground) for compensation adjustment and object tracking operation.

The projector apparatus 10 can at least include a projection lens 12, an image detection module 14, a drive module 16, an image calibration module 18 and an operation processor 20. The projection lens 12 can project a feature pattern to replace the physical correction cardboard. The image detection module 14 can acquire a detection image containing the feature pattern, and the image calibration module 18 can acquire a calibration image containing the feature pattern. The operation processor 20 can analyze the detection image and the calibration image for related computation. The drive module 16 can be electrically connected to the image detection module 14 and used to change a detection angle and/or a detection position of the image detection module 14. The operation processor 20 can be electrically connected to the projection lens 12, the image detection module 14, the drive module 16 and the image calibration module 18.

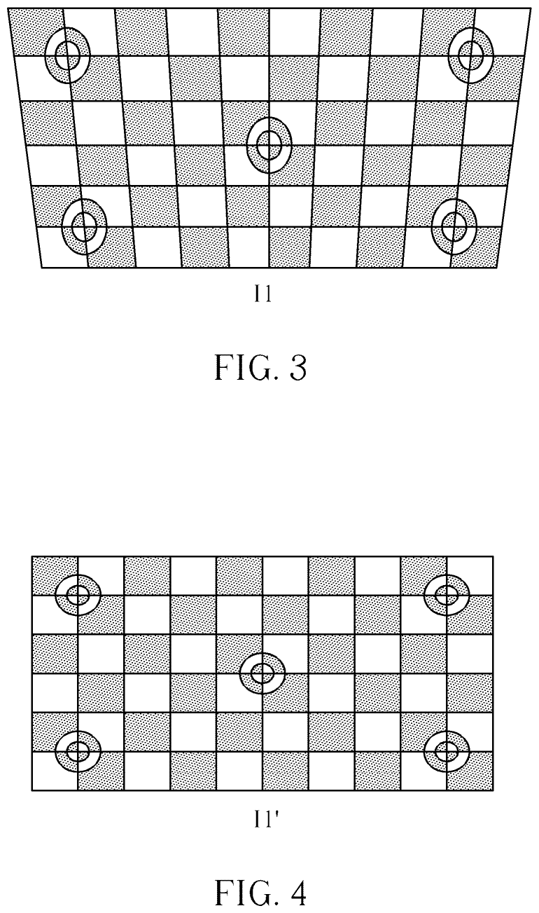

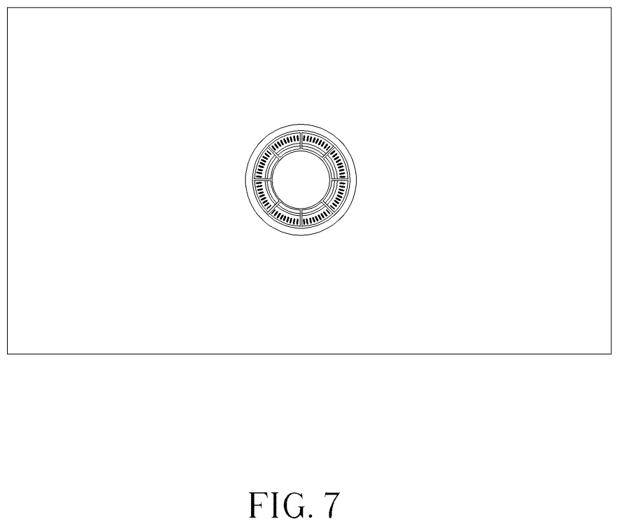

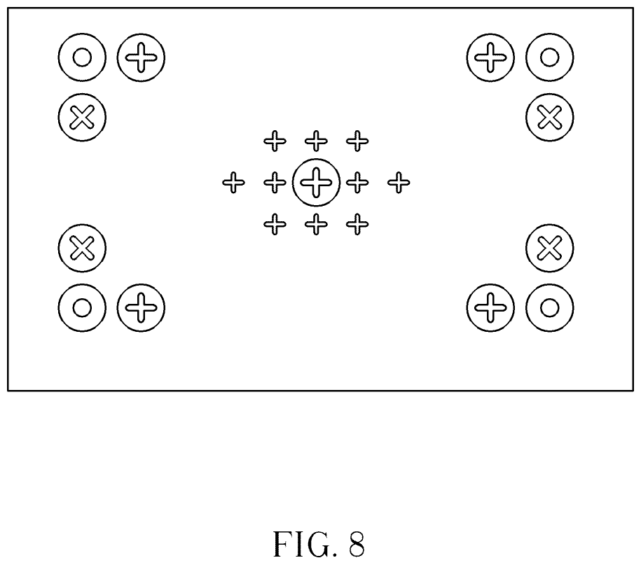

Pleases refer to FIG. 3 and FIG. 4. FIG. 3 is a diagram of the calibration image I1 captured by the image calibration module 18 before image calibration according to the embodiment of the present invention. FIG. 4 is a diagram of the calibration image I1′ captured by the image calibration module 18 after the image calibration according to the embodiment of the present invention. The feature pattern can be a common checkerboard pattern, as shown in FIG. 3 and FIG. 4. First, the projection lens 12 can project the feature pattern onto the projection area, and optionally adjust a zooming function of the projection lens 12 to a maximum level. Then, the projection lens 12 can actuate an autofocus function for adaptive adjustment, and the image calibration module 18 can capture the calibration image I1 that contains the feature pattern. The feature pattern may have a distortion and deformation phenomenon before executing the image calibration, as shown in FIG. 3. It should be mentioned that the feature pattern is not limited to the checkerboard pattern shown in FIG. 4, and can be the pattern with any other symbols. Please refer to FIG. 7 and FIG. 8. FIG. 7 and FIG. 8 are diagrams of the feature pattern according to other embodiments of the present invention. The feature pattern may be designed as a ring pattern (which can be shown in FIG. 7) or any specific symbol pattern (which can be shown in FIG. 8); variation of the feature pattern can depend on a design demand.

The image calibration module 18 can utilize the projection lens 12 to capture the required calibration image I1, or may utilize other projection lens or a combination of a VCSEL (vertical cavity surface emitting laser) module, a TOF (Time of Flight) sensor, and/or iTOF (indirect Time of Flight) sensor to compute the distance and the angle of the projector apparatus 10 relative to the projection area, so as to compute the calibration angle in the following process; computation of the distance, the angle or related information is not limited to the foresaid embodiments, and depends on the design demand.

The operation processor 20 can utilize the calibration image I1 to compute the calibration angle of the feature pattern after calibration by keystone correction technology through several methods, such as the calibration angle of the calibration image I1 shown in FIG. 3 converted into the calibration image I1′ shown in FIG. 4. The first calibration method is that the operation processor 20 can directly analyze deformation of the feature pattern inside the calibration image I1 by image recognition technology, such as a keystone correction result of s trapezoid form shown in FIG. 3 converted into a rectangle form shown in FIG. 4, and the calibration angle can be computed accordingly. The second calibration method can utilize the ToF sensor (which is not marked in the figures) of the image calibration module 18 to acquire the distance and the angle of the projector apparatus 10 relative to the projection area, and the calibration angle can be computed by a distance detection result of the ToF sensor.

The third calibration method can optionally utilize a structured light sensor (which is not marked in the figures) of the image calibration module 18 to project a structured light pattern onto the projection area, and analyze a stripe deformation result of the structured light pattern received by the structured light sensor for accordingly computing the calibration angle. Process of acquiring the calibration angle in the present invention is not limited to the foresaid three calibration methods, and depends on the design demand. When the calibration angle is acquired, the operation processor 20 can drive the projection lens 12 to project the feature pattern that is processed by the image calibration (which means the keystone correction technology) in accordance with the calibration angle, such as the calibration image I1′ shown in FIG. 4.

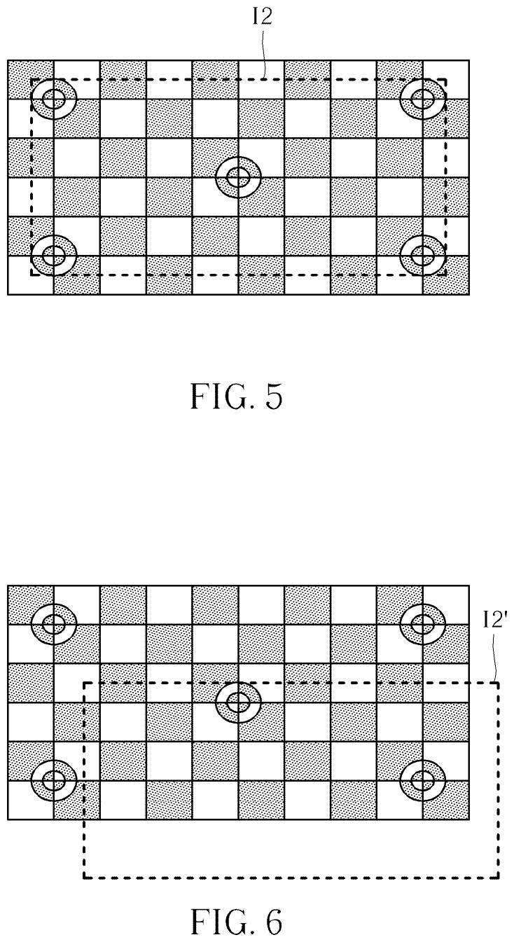

Please refer to FIG. 5 and FIG. 6. FIG. 5 is a diagram of the detection image I2 captured by the image detection module 14 before position calibration according to the embodiment of the present invention. FIG. 6 is a diagram of the detection image I2′ captured by the image detection module 14 after the position calibration according to the embodiment of the present invention. First, the image detection module 14 which is disposed on the projection lens 12 can capture the detection image I2 or I2′ that contains the contain feature pattern (after the keystone correction). The projection lens 12 can optionally adjust the zooming function to the maximum level; the operation processor 20 can compare the detection image I2 or I2′ with a preset condition, and decide whether to utilize the drive module 16 to adjust the detection angle of the image detection module 14 in accordance with a comparison result of the detection image I2 or I2′ and the preset condition.

For example, the preset condition can be frame edges of the feature pattern. As shown in FIG. 5, when the operation processor 20 determines that the detection image I2 does not conform to the preset condition, the frame edges of the feature pattern are not appeared inside the detection image I2, and the operation processor 20 can utilize the drive module 16 to adjust the detection angle of the image detection module 14 in accordance with the calibration angle of the feature pattern (which can be interpreted as conversion difference between the calibration image I1 shown in FIG. 3 and the calibration image I1′ shown in FIG. 4). After adjustment of the detection angle, the image detection module 14 can capture the detection image I2′ containing the feature pattern again, and compare the detection image I2′ with the preset condition; when the detection image I2′ conforms to the preset condition (which means the frame edges of the feature pattern are appeared inside the detection image I2), the detection image I2′ can be analyzed to acquire a feature parameter and a related compensation parameter of the feature pattern, for the compensation adjustment and the object tracking operation as mentioned above.

It should be mentioned that the image detection module 14 can optionally include a light source (such as an infrared light module or a laser module not marked in the figures) used to emit an illumination beam when capturing the detection image I2 or I2′. The operation processor 20 can utilize the drive module 16 to adjust the detection angle of the image detection module 14 relative to the case or the projection area of the projector apparatus 10; without a need of the user manually adjusting or replacing the position or angle of the projector apparatus 10, a detection range of the image detection module 14 can accurately align with an effective region of the projector apparatus 10, and the projector apparatus 10 can accurately decide an area of hitting point. In addition, the drive module 16 can be set as a single-axis motor or a multi-axis motor, which can be used to adjust the detection angle and/or a displacement of the image detection module 14; a type of the drive module 16 can depend on the design demand.

In conclusion, the projector apparatus of the present invention can utilize the projection lens to project the feature pattern (such as the checkerboard pattern) onto the projection area (such as the ground below the projector apparatus), for replacing the conventional correction cardboard. The feature pattern may be distorted or deformed due to an installation angle of the projector apparatus, and the image calibration module can capture the calibration image containing the feature pattern; then, the projector apparatus can compute the calibration angle of the feature pattern converted from the trapezoid form to the rectangle form via the keystone correction technology by several calibration methods (for example, analysis of the calibration image, the distance detection result of the ToF sensor, or the stripe deformation result of the structured light sensor), and therefore the projection lens can project the feature pattern without distortion and deformation based on the calibration angle.

After that, the image detection module can capture the detection image that contains the calibrated feature pattern, and analyze the detection image for frame analysis (which means detecting whether the frame edges of the feature pattern are appeared inside the detection image). If the frame analysis is correctly completed, the projector apparatus can utilize the image detection module to focus on the feature pattern projected by the projection lens onto the projection area for acquiring the detection image, and the detection image can be analyzed to acquire the position, the size, the direction, and any related parameters of the effective region (such as the area of hitting point) inside the projection area for the compensation adjustment and the object tracking operation. If the frame analysis is failed, the detection range of the image detection module may not align with the effective region inside the projection area, and the drive module of the projector apparatus can adaptively adjust the detection angle of the image detection module relative to the projection area in accordance with the calibration angle, and then the image detection module can accurately and effectively capture the detection image containing the calibrated feature pattern.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projector apparatus of automatically calibrating position of an image detection module, the projector apparatus comprising:
a projection lens adapted to project a feature pattern;
the image detection module disposed adjacent to the projection lens and adapted to acquire a detection image containing the feature pattern;
a drive module electrically connected to the image detection module; and
an operation processor electrically connected to the projection lens, the image detection module and the drive module, and adapted to compare the detection image with a preset condition and then decide whether to adjust a detection angle of the image detection module by the drive module in accordance with a comparison result.

2. The projector apparatus of claim 1, wherein the preset condition is frame edges of the feature pattern, and the operation processor determines the detection image conforms to the preset condition when the frame edges are appeared within the detection image.

3. The projector apparatus of claim 1, wherein the image detection module comprises a light source adapted to emit an illumination beam when capturing the detection image.

4. The projector apparatus of claim 1, wherein the operation processor further analyzes the detection image to acquire at least one feature parameter and a related compensation parameter of the feature pattern when the detection image conforms to the preset condition.

5. The projector apparatus of claim 1, wherein the operation processor further adjusts the detection angle of the image detection module by the drive module in accordance with a calibration angle of the feature pattern when the detection image does not conform to the preset condition.

6. The projector apparatus of claim 5, wherein the image detection module that has adjusted the detection angle further captures another detection image containing the feature pattern, the operation processor further compares the another detection image with the preset condition and decides whether to adjust the detection angle of the image detection module again by the drive module.

7. The projector apparatus of claim 5, wherein the operation processor utilizes ToF (Time of Flight) technology or image recognition technology to analyze a keystone correction result of the feature pattern for acquiring the calibration angle.

8. The projector apparatus of claim 1, wherein the operation processor utilizes the drive module to adjust the detection angle of the image detection module, so that a detection range of the image detection module aligns with an effective region of the projector apparatus.

9. The projector apparatus of claim 1, wherein the drive module is a single-axis motor or a multi-axis motor adapted to adjust the detection angle and a displacement of the image detection module.

10. The projector apparatus of claim 1, further comprising:
an image calibration module electrically connected to the operation processor, and adapted to acquire a calibration image containing the feature pattern;
wherein the operation processor utilizes the calibration image to compute a calibration angle of the feature pattern acquired by calibration through keystone correction technology.

11. The projector apparatus of claim 10, wherein the operation processor analyzes deformation of the feature pattern within the calibration image to compute the calibration angle.

12. The projector apparatus of claim 10, wherein the image calibration module comprises a ToF (Time of Flight) sensor, and the operation processor computes the calibration angle in accordance with a distance detection result of the ToF sensor.

13. The projector apparatus of claim 10, wherein the image calibration module comprises a structured light sensor, and the operation processor computes the calibration angle in accordance with a stripe deformation result of the structured light sensor.

14. The projector apparatus of claim 10, wherein the operation processor drives the projection lens via the calibration angle to project the feature pattern processed by the keystone correction technology.

15. The projector apparatus of claim 10, wherein the operation processor computes the detection angle required by the image detection module in accordance with the calibration angle.
